(19) United States
(12) Patent Application Publication
(10) Pub. No.: US 2004/0059927 A1
(43) Pub. Date: Mar. 25, 2004

(54) Sealed memory IC in a MP3 or WMA player shaped like recording artist

(76) Inventor: I Ming Chen, Taipei Hsien (TW)

Correspondence Address: Donald W. Meeker, Patent Agent, 924 E. Ocean Front #E, Newport Beach, CA, 92661, US

(21) Appl. No.: 10/253,872

(22) Filed: Sep. 23, 2002

(51) Int. Cl. H04L 9/00

(52) U.S. Cl. 713/189; 705/57

(57) ABSTRACT

A sealed memory IC chip is confined within a case with a digital signal processor, a digital-analog converter, and an amplifier, together capable of producing audible sound from the digitally recorded sound on the sealed memory IC chip. The sound is transmitted to a headphone jack and to a headphone. The case is shaped and has the image of the recording artist whose music or other sound data is stored on the chip.

### BACKGROUND OF THE INVENTION

1. Field of the Invention

The present invention relates to portable music players and in particular to a music player with the music digitally stored on a sealed memory chip using MP3 or WMA technology in a form that cannot be digitally duplicated and housed in a case shaped like the performing artist of the music.

2. Description of the Prior Art

Portable music players of all kinds are very popular, including radios, tape players, CD players, and MP3 players. Characteristic of the MP3 players is that the music is digitally downloaded from the internet and freely exchanged between individuals.

A normal MP3 music player has a connector for external device to download music to a removable, reusable memory (flash memory such as smart media, memory stick, etc). Thus music may be digital duplicated with the original high quality sound easily.

U.S. Pat. No. 6,367,019, issued Apr. 2, 2002 to Ansell, et al., shows data, such as a musical track, stored as a secure portable track (SPT) which can be bound to one or more players and can be bound to a particular storage medium, restricting playback of the SPT to the specific players and ensuring that playback is only from the original storage medium. The SPT is bound to a player by encrypting data of the SPT using a storage key which is unique to the player, is difficult to change, and is held in strict secrecy by the player. The SPT is bound to a particular storage medium by including data uniquely identifying the storage medium in a tamper-resistant form, e.g., cryptographically signed. The SPT can also be bound to the storage medium by embedding cryptographic logic circuitry, e.g., integrate circuitry, in the packaging of the storage medium. The SPT is bound by encrypting an encryption key using the embedded logic. By using unique cryptographic logic, only that particular storage medium can decrypt the encryption key and, therefore, the data of the SPT encrypted with the encryption key. To allow a user to playback the SPT on a number of players, players can share storage keys with one another. Such key sharing is done in a cryptographically secure manner. Before downloading an SPT to a particular external player, the ability of the external player to enforce restrictions placed upon the SPT is verified.

U.S. Pat. No. 5,677,953, issued Oct. 14, 1997 to Janet L. Dolphin, claims a system and method of the present invention providing the support of high density removable media, such as CD-ROM or MO, to be used as a distributed media for storing data where access thereto is securely restricted. Through this system and method, the secure periodic distribution of several different sets of data information to the end user is achieved with access control selectively performed by at the user's site through communication with the billing/access center. User billing is based on the purchase of the decryption access codes as indicated by the access code attributes encoded on the media. Access code availability is further controlled by selectively providing for updates of decryption access codes.

U.S. Pat. No. 6,423,892, issued 7/23/2002 to Muralidharan Ramaswamy, provides a method, wireless MP3 player and system for downloading MP3 files from MP3 content sites that are in data communication with the Internet. The method comprises the steps of providing a wireless application protocol network in data communication with the Internet, a music server in data connection with the Internet, at least one MP3 content site in data communication with the Internet, and a wireless MP3 player having circuitry for establishing data communications with the wireless application protocol network and a display for displaying information generated by the music server. The method further comprises the steps of operating the wireless MP3 player to establish data communication with the wireless application protocol network so as to establish data communication between the wireless MP3 player and the Internet, establishing data communication between the wireless MP3 player and the music server, inputting data into the wireless MP3 player that defines particular music desired by a user, operating the wireless MP3 player so as to instruct the music server to effect a search of the MP3 content sites to locate MP3 files relating to the desired music, displaying on the wireless MP3 player at least one title of an MP3 file located in the search, operating the wireless MP3 player to select the title, operating the wireless MP3 player to instruct the music server to upload an MP3 file that corresponds to the selected title, and downloading the uploaded MP3 file to the wireless MP3 player.

U.S. Pat. No. 5,636,276, issued Jun. 3, 1997 to Rolf Brugger, describes distribution of music information from a central memory device (2) via a communications network (4) to a terminal (6), this information is organized in a digital music information object. The latter comprises a core having basic information relating to the music information object, as well as a number of additional layers having the actual music information. The core includes an encryption table, on the basis of which an encryption module (30) of the central memory device (2) and a decryption module (32) of the terminal (6) respectively encrypt and decrypt the music information object. Furthermore, an interpretation module (34) is provided in the terminal (6) for reproduction conditioning of the music information object, which interpretation module (34) accesses information for checking the authorized use of the music information object, which information is stored in an authorization device (36) and identifies the terminal or the consumer. The invention thus creates a technique for distribution of digital music information which on the one hand provides effective mechanisms for the protection of copyrights and on the other hand makes possible increased services for the consumer.

U.S. Pat. No. 5,033,084, issued 7/16/1991 to David A. Beecher, discloses a method and apparatus for protecting software used in an electronic system. An electronic key is associated with the software, which is at least partially unreadable unless modified. The electronic system using the software to be protected receives the electronic key, and reads the software to determine that the electronic key and software are associated. The system then modifies the software to render it readable and identifies the software with the electronic system by storing an identifier of the system with the software. Finally, the system modifies the electronic key to render it useless.

U.S. Pat. No. 5,034,980, issued Jul. 23, 1991 to Satoshi Kubota, indicates a microprocessor encrypted with a unique code during its manufacture. When copy protection of software designed to operate with the microprocessor is desired, software is encrypted to function uniquely with that microprocessor. The software is ciphered such that only the unique cryptographic code in the microprocessor can decipher it. If the software or its copy is executed on another processor, the deciphering cannot occur. Two-pairs of CMOS transistors form each bit of the code integrated with the microprocessor.

U.S. Pat. No. 6,313,386, issued Nov. 6, 2001 to Capobianco, et al., illustrates an apparatus for playing music. The apparatus includes a manually movable spring, a generator mechanically coupled to the manually movable spring, and a controller electrically coupled to the generator. The apparatus also includes a memory interface coupled to the controller, the memory interface, in an operative configuration, coupled to a removable memory device containing digital music data. The apparatus can further include an audio interface coupled to the controller, the audio interface, in an operative configuration, coupled to a speaker.

It is desirable, especially by the recording industry and recording artists, to sell music in a format that cannot be duplicated, especially not duplicated in a high quality digital format, thereby discouraging the free distribution of the music.

### SUMMARY OF THE INVENTION

An object of the present invention is to provide a high quality digital using MP3 or WMA technology on a sealed memory chip that may not be digitally duplicated.

Another object of the present invention is to provide a portable music player using MP3 or WMA technology in a case shaped like the recording artist performing the music.

One more object of the present invention is to provide a music souvenir which could be sold at concerts and elsewhere with a case having the image and shape of the recording artist whose music is on the sealed memory chip inside the case.

In brief, a CD quality music player has preferably one to four recordings, in MP3 format, permanently embedded on a sealed memory chip, housed in a case (which has the figure characteristic of the music's artist) that can not be digitally duplicated.

The present invention has a sealed memory chip with music permanently embedded inside the device. It is not possible for an ordinary user to digitally copy the music in it.

The case of this device preferably has the shape and image of the music artist of the embedded song titles.

An advantage of the present invention is that it provides high quality digitally recorded music in a player in a format that cannot be digitally duplicated.

Another advantage of the present invention is that it provides a memorable souvenir of the recording artist and the recording artist's music.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view showing a portable music player case shaped like the recording artist, in this case Elvis Presley;

FIG. 2 is a diagrammatic view showing the operating components of the invention which are housed within the case of FIG. 1;

FIG. 3 is a diagrammatic view showing the operating components of a prior art MP3 music player;

FIG. 4 is a diagrammatic view showing the operating components of the present invention.

### BEST MODE FOR CARRYING OUT THE INVENTION

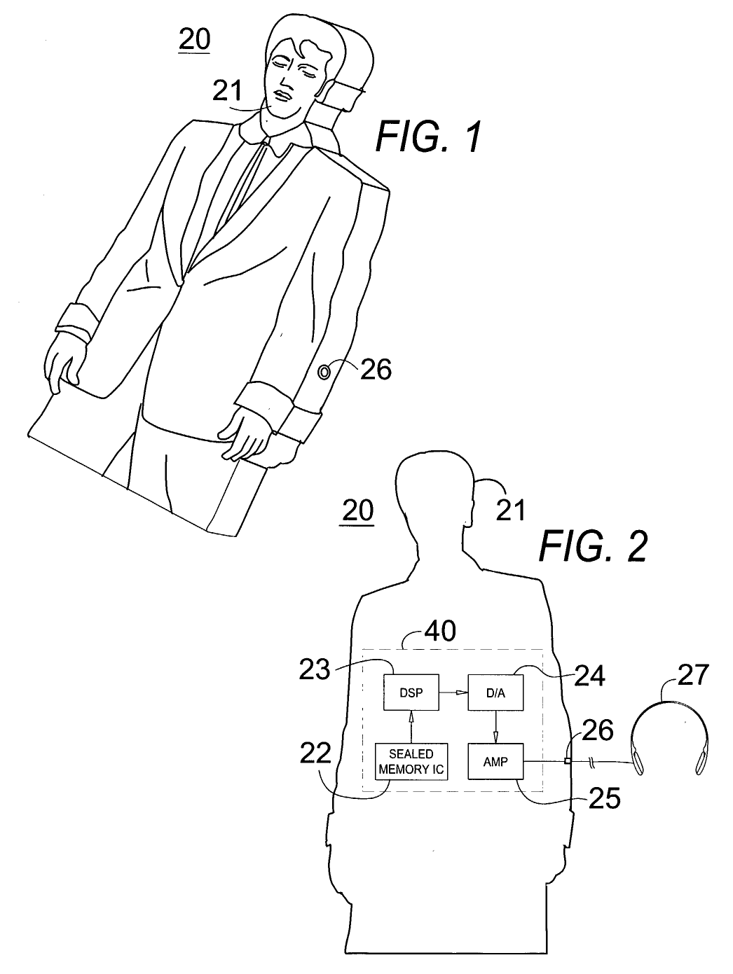

In FIGS. 1, 2 and 4, a portable sound player device 20 has digitally recorded sound which is not digitally duplicable. A case 21 houses a digital signal processor (DSP) 23, a digital-analog converter (D/A) 24 and an amplifier (AMP) 25 together capable of producing audible sound from digitally recorded sound. A sealed memory IC means, such as an IC chip 22, stores digitally recorded sound and is housed within the case 21 to provide digital signals to the digital signal processor 23.

The sound, which may be music, is recorded and stored on the sealed read only memory means, the IC chip (SEALED ROM) 22, using MP3 or WMA technology.

The case 21 is preferably shaped like and bears an image of a recording artist, such as Elvis Presley, who made the recording(s) stored on the sealed memory chip 22.

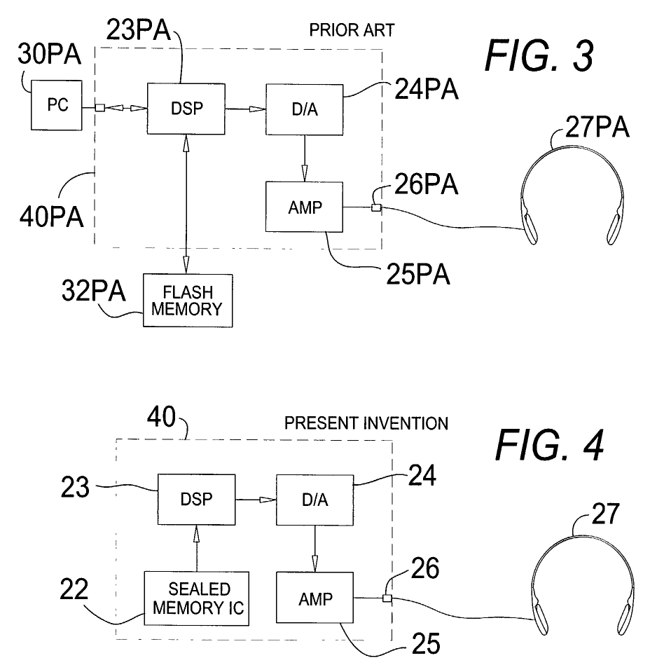

In FIG. 3, a prior art MP3 player uses a flash RAM memory device 32PA which is removable from the confining interior area 40PA of the prior art device and is also able to be duplicated digitally. Furthermore, an input device, such as a personal computer (PC) 30PA, can input and output digital information from the prior art system, including uploading and downloading to and from the internet. The digital signal processor (DSP) 23PA, digital-analog converter (D/A) 24PA and amplifier (AMP) 25PA, operate in a similar fashion to the present invention and together are capable of producing audible sound from digitally recorded sound and outputting that sound, such as music, through a headphone jack 26PA to a headphone 27PA.

In FIG. 4, for the present invention the sound, which may be music, is recorded and stored on the sealed read only memory means, the IC chip (SEALED-MEMORY IC) 22, preferably using MP3 or WMA technology. The chip (SEALED MEMORY IC) 22 is sealed within the confining interior 40 of the case and only feeds signals to the digital signal processor (DSP) 23, which sends to the digital-analog converter (D/A) 24 and amplifier (AMP) 25, which together are capable of producing audible sound from digitally recorded sound and outputting that sound, such as music, through a headphone jack 26 to a headphone 27. The recorded information, such as music, cannot be digitally duplicated.

It is understood that the preceding description is given merely by way of illustration and not in limitation of the invention and that various modifications may be made thereto without departing from the spirit of the invention as claimed.

What is claimed is:

1. A sound player device having digitally recorded sound which is not digitally duplicable, the device comprising:
a case housing a digital signal processor, a digital-analog converter and an amplifier together capable of producing audible sound from digitally recorded sound;
a sealed memory IC means for storing digitally recorded sound housed within the case to provide digital signals to the digital signal processor.

2. The device of claim 1 wherein the sound is recorded and stored on the sealed memory IC means using MP3 or WMA technology.

3. The device of claim 1 wherein the case is shaped like and bears an image of a recording artist who made a recording stored on the sealed memory IC.

4. The device of claim 1 wherein the sealed memory IC means comprises a memory chip.
